(19) United States
(12) Patent Application Publication
(10) Pub. No.: US 2015/0123362 A1
(43) Pub. Date: May 7, 2015

(54) WHEELED COMPARTMENTALIZED CART

(71) Applicants: Daniel David Manning, Clinton, UT (US); Craig Arthur Johnson, Sunset, UT (US)

(72) Inventors: Daniel David Manning, Clinton, UT (US); Craig Arthur Johnson, Sunset, UT (US)

(21) Appl. No.: 14/530,417

(22) Filed: Oct. 31, 2014

Related U.S. Application Data
(60) Provisional application No. 61/898,563, filed on Nov. 1, 2013.

(51) Int. Cl. B62B 1/02; B62B 1/26

(52) U.S. Cl. CPC B62B 1/02; B62B 1/26
USPC 280/47.19

(57) ABSTRACT

A cart is provided to carry chairs and a large shade umbrella. The cart, regardless of configuration, will also contain a number of convenience pockets to carry stadium blankets, binders, tablet PCs, sunscreen, etc. It also contains a large pocket with a thermal lining in which to carry beverages. This pocket and lining is removable in order to facilitate washing in the event of a spilled beverage. This embodiment is designed with a shoulder strap which facilitates hands-free towing. This is especially helpful for the average “soccer mom” who needs those hands free to corral children while in transit to an event.

### FIELD OF THE INVENTION

The present invention relates to a cart, and particularly to a cart for use in transportation of participation and spectator equipment to and from events.

### BACKGROUND OF THE INVENTION

Carts are known in the art. Such carts include many types, such as shopping carts, sewing carts, and cleaning carts, among other known types.

It is, however, a problem in the art to provide a cart for use in transportation of participation and spectator equipment to and from events.

In a typical example of a need in the art, take the example of particants and spectators at a long-distance obstacle challenge event. At one such exemplary event, held at Soldier Hollow in Midway, Utah, it was over 100 degrees and sunny with no cloud cover. Participants and their spouses attended and it was desirable to provide the some of the spouses of the participants with shade and seating during the 3+ hour event. Unfortunately, as is the case with many events, the parking was a half mile or more from the spectator area. The spouses, as well as hundreds of other spectators, ended up roughing it in the sun because it was simply too difficult to transport camp chairs and shade canopy from their cars to the location of the event.

Furthermore, there is a need in the art to transport other items as well, to and from events. For example, there are many bags, backpacks, and carts are designed to get goods to events (e.g., baseball bags, lacrosse bags, golf bags/carts), but these are not specifically designed to get the spectator equipment to the event.

### SUMMARY OF THE INVENTION

From the foregoing, it is seen that it is a problem in the art to provide a device meeting the above requirements. According to the present invention, a device and process are provided which meets the aforementioned requirements and needs in the prior art.

More particularly, the invention relates to a cart, and particularly to a cart for use in transportation of participation and spectator equipment to and from events. The cart of the present invention is provided with a base, a cap, rigid compartments, wheels, an axle, a bag, and assorted pockets.

In one embodiment, the cart is used in transportation of participation and spectator equipment to and from events, and comprises:

a base, an axle, wheels supported on said axle, a top member having an outer peripheral band portion and a central H-shaped portion; a pair of main support legs connected to one side of said top member; a plurality of long rods separating said top member and said base; a pivotable member connected to said pair of main support legs; and a bag having a plurality of pockets.

Other objects and advantages of the present invention will be more readily apparent from the following detailed description when read in conjunction with the accompanying drawings.

### BRIEF DESCRIPTION OF THE DRAWINGS

FIG. 1 is an isometric view of a front side of a support structure for a wheeled cart for use in transportation of participation and spectator equipment to and from events, according to the present invention.

FIG. 2 is an isometric view of a rear side the support structure for a wheeled cart of FIG. 1.

FIG. 3 is a front elevational view of the structure of FIG. 1.

FIG. 4 is a rear elevational view of the structure of FIG. 1.

FIG. 5 is a side elevational view of the structure of FIG. 1, as viewed from the left of FIG. 3, the right side being a mirror image of FIG. 5.

FIG. 6 is a top elevational view of the structure of FIG. 1.

FIG. 7 is a bottom elevational view of the structure of FIG. 1.

FIG. 8 is an explosed view of the device of FIGS. 1-7.

FIG. 9 is a top elevational view of a bottom member used in the structure of FIG. 1.

FIG. 10 is an isometric view of the bottom member used in the structure of FIG. 1.

FIG. 11 is an isometric view of the bottom member as viewed from the rear of FIG. 10.

FIG. 12 is a bottom elevational view of the bottom member of FIG. 9.

FIG. 13 is a side elevational view of the bottom member of FIG. 9.

FIG. 14 is a rear elevational view of the bottom member of FIG. 9.

FIG. 15 is a front elevational view of the bottom member of FIG. 9.

FIG. 16 is a top elevational view of a top member used in the structure of FIG. 1.

FIG. 17 is an isometric view of the top member used in the structure of FIG. 1.

FIG. 18 is an isometric view of the top member as viewed from the rear of FIG. 17.

FIG. 19 is a bottom elevational view of the top member of FIG. 16.

FIG. 20 is a right side elevational view of the top member of FIG. 16.

FIG. 21 is a left side elevational view of the top member of FIG. 16.

FIG. 22 is a rear elevational view of the top member of FIG. 16.

FIG. 23 is a front elevational view of the top member of FIG. 16.

FIG. 24 is a front elevational view of a wheel used in the support structure of FIG. 1.

FIG. 25 is a rear elevational view of the wheel of FIG. 24.

FIG. 26 is a side elevational view of the wheel of FIG. 24.

FIG. 27 is an isometric view of the wheel of FIG. 24.

FIG. 28 is an isometric view of the wheel of FIG. 24, viewed from the rear of FIG. 27.

FIG. 29 is a top elevational view of a connector member used in the support structure of FIG. 1.

FIG. 30 is a bottom elevational view of the connector member of FIG. 29.

FIG. 31 is a side elevational view of the connector member of FIG. 29.

FIG. 32 is an isometric view of the connector member of FIG. 29.

FIG. 33 is an isometric view of the connector member of FIG. 29, as viewed from the rear of FIG. 32.

FIG. 34 is a top elevational view of a washer member used in the support structure of FIG. 1.

FIG. 35 is an isometric view of the washer member of FIG. 34.

FIG. 36 is a side view of the washer member of FIG. 34.

FIG. 37 is a bottom elevational view of a bracket used in the support structure of FIG. 1.

FIG. 38 is a top elevational view of the bracket of FIG. 37.

FIG. 39 is a rear elevational view of the bracket of FIG. 37.

FIG. 40 is a front elevational view of the bracket of FIG. 37.

FIG. 41 is an isometric view of the bracket of FIG. 37.

FIG. 42 is an isometric view of the bracket of FIG. 37, as viewed from the rear of FIG. 41.

FIG. 43 is a side elevational view of the bracket of FIG. 37.

FIG. 44 is a front elevational view of a pivot support member used in the support structure of FIG. 1.

FIG. 45 is a rear elevational view of the pivot support member of FIG. 44.

FIG. 46 is a bottom elevational view of the pivot support member of FIG. 44.

FIG. 47 is a top elevational view of the pivot support member of FIG. 44.

FIG. 48 is a side elevational view of the pivot support member of FIG. 44.

FIG. 49 is an isometric view of the pivot support member of FIG. 44.

FIG. 50 is an isometric view of the pivot support member of FIG. 44, as viewed from the rear of FIG. 49.

FIG. 51 is a bottom elevational view of an end cap used in the support structure of FIG. 1.

FIG. 52 is a top elevational view of the end cap of FIG. 51.

FIG. 53 is a side elevational view of the end cap of FIG. 51.

FIG. 54 is an isometric view of the end cap of FIG. 51.

FIG. 55 is an isometric view of the end cap of FIG. 51, as viewed from the rear of FIG. 54.

FIG. 56 is a top elevational view of a pin used in the support structure of FIG. 1.

FIG. 57 is a bottom elevational view of the pin of FIG. 56.

FIG. 58 is a side elevational view of the pin of FIG. 56.

FIG. 59 is an isometric view of the pin of FIG. 56.

FIG. 60 is an isometric view of the pin of FIG. 56, as viewed from the rear of FIG. 59.

FIG. 61 is a bottom elevational view of a cover used in the support structure of FIG. 1.

FIG. 62 is a top elevational view of the cover of FIG. 61.

FIG. 63 is a side elevational view of the cover of FIG. 61.

FIG. 64 is an isometric view of the cover of FIG. 61.

FIG. 65 is an isometric view of the cover of FIG. 61, as viewed from the rear of FIG. 64.

FIG. 66 is a top elevational view of a threaded fastener used in the support structure of FIG. 1.

FIG. 67 is a bottom elevational view of the threaded fastener of FIG. 66.

FIG. 68 is a side elevational view of the threaded fastener of FIG. 66.

FIG. 69 is an isometric view of the threaded fastener of FIG. 66.

FIG. 70 is an isometric view of the threaded fastener of FIG. 66, as viewed from the rear of FIG. 69.

FIG. 71 is a rear elevational view of an end cap used in the support structure of FIG. 1.

FIG. 72 is a front elevational view of the end cap of FIG. 71.

FIG. 73 is a side elevational view of the end cap of FIG. 71.

FIG. 74 is an isometric view of the end cap of FIG. 71.

FIG. 75 is an isometric view of the end cap of FIG. 71, as viewed from the rear of FIG. 74.

FIG. 76 is a side elevational view of a pivotable support member used in FIG. 1.

FIG. 77 is a front elevational view of the pivotable support member of FIG. 76.

FIG. 78 is an isometric view of the pivotable support member of FIG. 76.

FIG. 79 is a front elevational view of a support leg used in FIG. 1.

FIG. 80 is a rear elevational view of the support leg of FIG. 79.

FIG. 81 is an end elevational view of the support leg of FIG. 79.

FIG. 82 is an isometric view of the support leg of FIG. 79.

FIG. 83 is an isometric view of the support leg of FIG. 79, as viewed from the rear of FIG. 82.

FIG. 84 is a front elevational view of a long support rod used in FIG. 1.

FIG. 85 is an end elevational view of the long support rod of FIG. 84.

FIG. 86 is an isometric view of the long support rod of FIG. 84.

FIG. 87 is an isometric view of a short support rod used in FIG. 1.

FIG. 88 is a side elevational view of the long support rod of FIG. 87.

FIG. 89 is an end view of the long support rod of FIG. 87.

FIG. 90 is a schematic front elevational view of a wheeled compartmentalized cart according to the present invention.

FIG. 91 is a schematic side elevational view of a wheeled compartmentalized cart according to the present invention.

FIG. 92 is a schematic isometric view of a wheeled compartmentalized cart of FIGS. 90 and 91, according to the present invention.

FIG. 93 is a schematic top elevational view of a wheeled compartmentalized cart of FIGS. 90-92, according to the present invention.

### DETAILED DESCRIPTION OF THE INVENTION

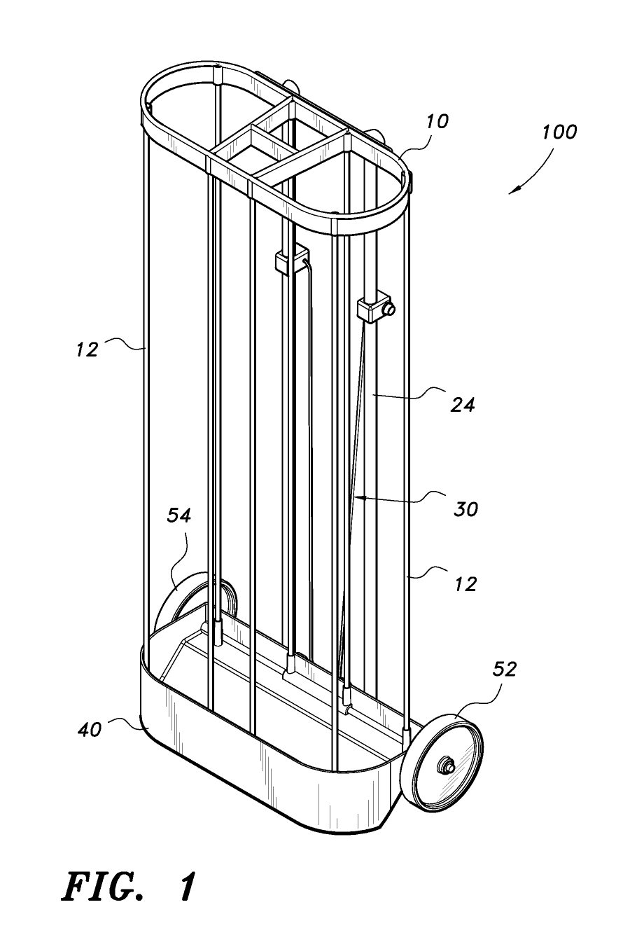

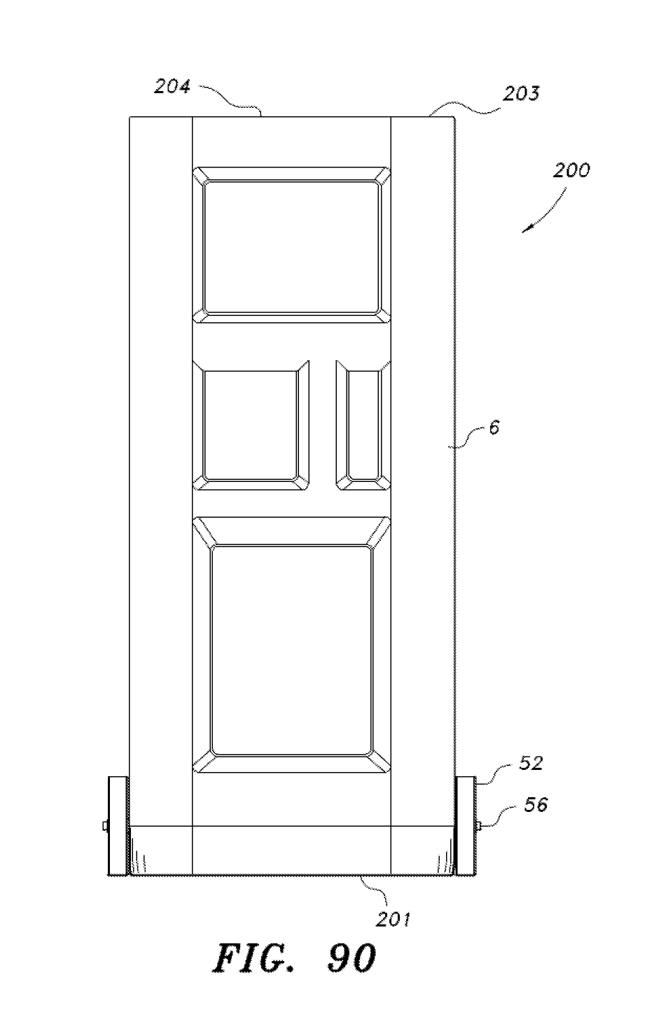

FIG. 1 is an isometric view of a front side of a support structure 100 for a wheeled cart 200 (shown in FIGS. 90-93) for use in transportation of participation and spectator equipment to and from events, according to the present invention. The support structure 100 includes a top member 10, a bottom member 40, a pair of wheels 52 and 54, a plurality of long support rods 12, a pivotable support member 30, and a pair of support legs 22 and 24.

The cart 200 is provided to carry chairs and a large shade umbrella. The cart 200, regardless of configuration, will also contain a number of convenience pockets to carry stadium blankets, binders, tablet PCs, sunscreen, etc. It also contains a large pocket with a thermal lining in which to carry beverages. This pocket and lining is removable in order to facilitate washing in the event of a spilled beverage. This embodiment is designed with a shoulder strap which facilitates hands-free towing. This is especially helpful for the average “soccer mom” who needs those hands free to corral children while in transit to an event.

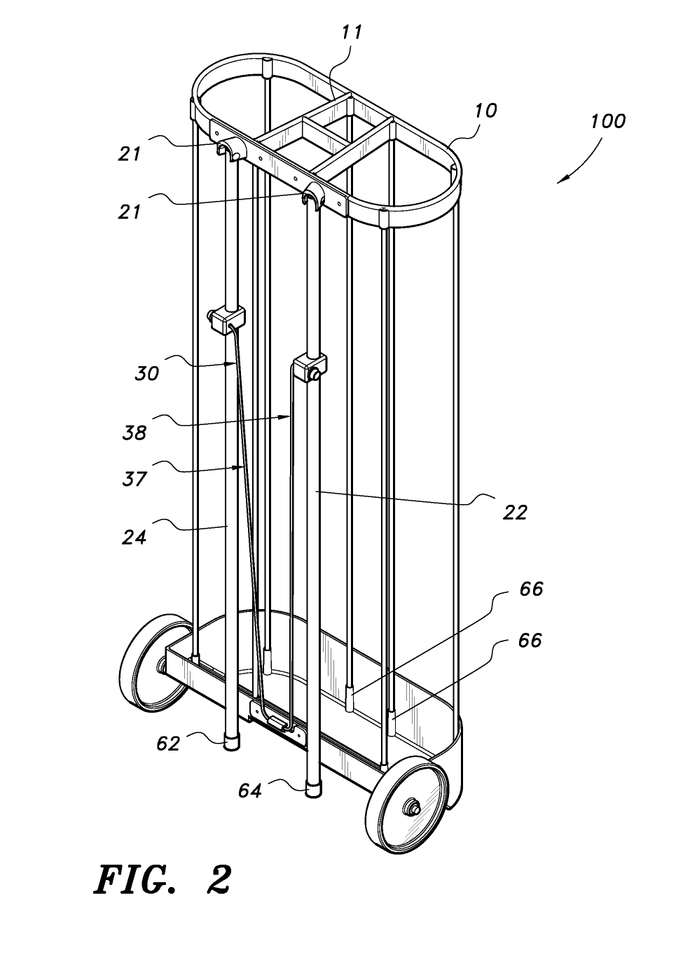

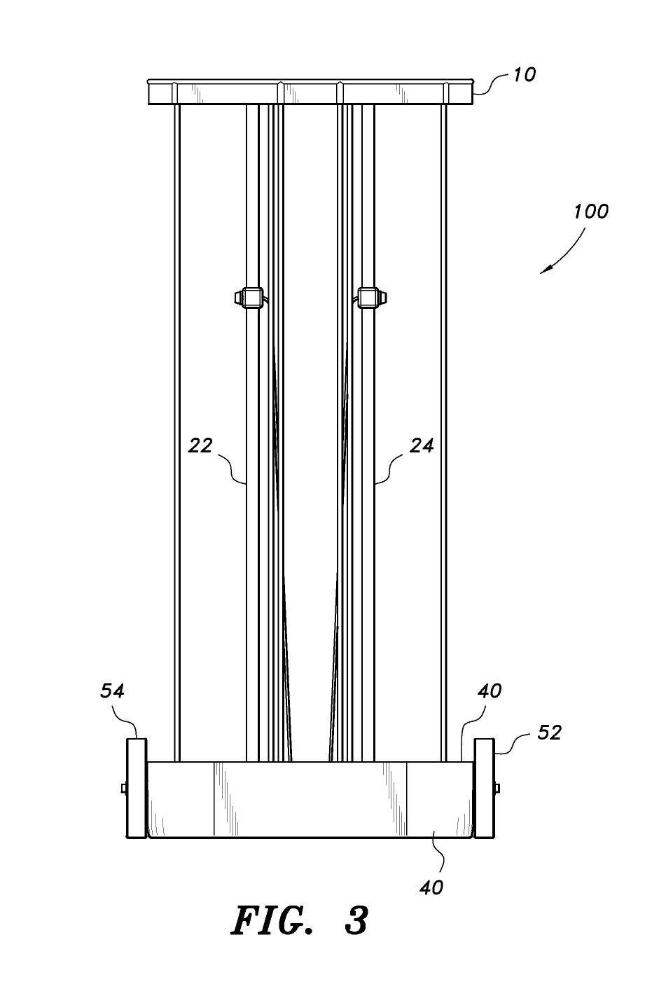

FIG. 2 is an isometric view of a rear side the support structure 100 for a wheeled cart of FIG. 1. The parts are as described in the above. In addition, this view shows the leg portions 37 and 38 of the member 30, a bracket 20 (shown in the following figures) having protruding portions 21, end caps 62 and 64, socket portions 66, and an H-shaped central portion of the top member 10. FIG. 3 is a front elevational view of the structure of FIG. 1.

FIG. 4 is a rear elevational view of the structure 100 of FIG. 1. A pivot support member 32 is shown, for releasably securing the lowermost end of the pivotable support member 30. A pair of connector members 33 are shown, for pivotably supporting the uppermost ends of the pivotable support member 30.

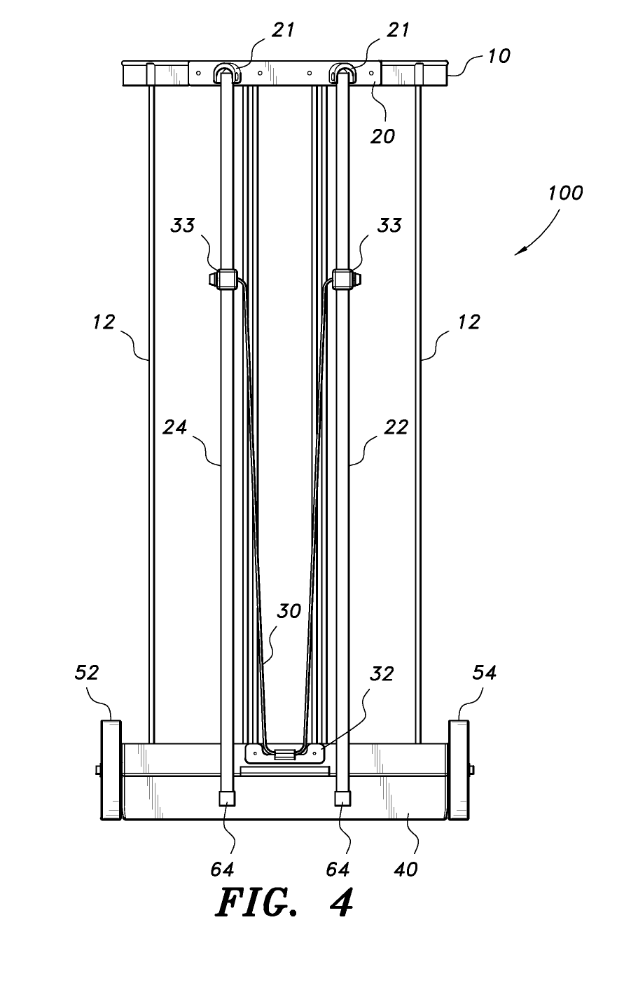

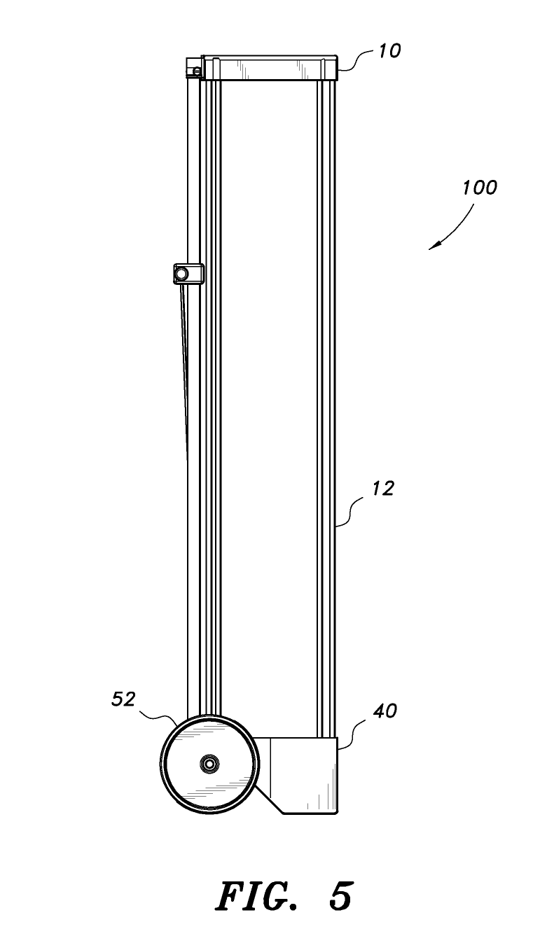

FIG. 5 is a side elevational view of the structure 100 of FIG. 1, as viewed from the left of FIG. 3, the right side being a mirror image of FIG. 5.

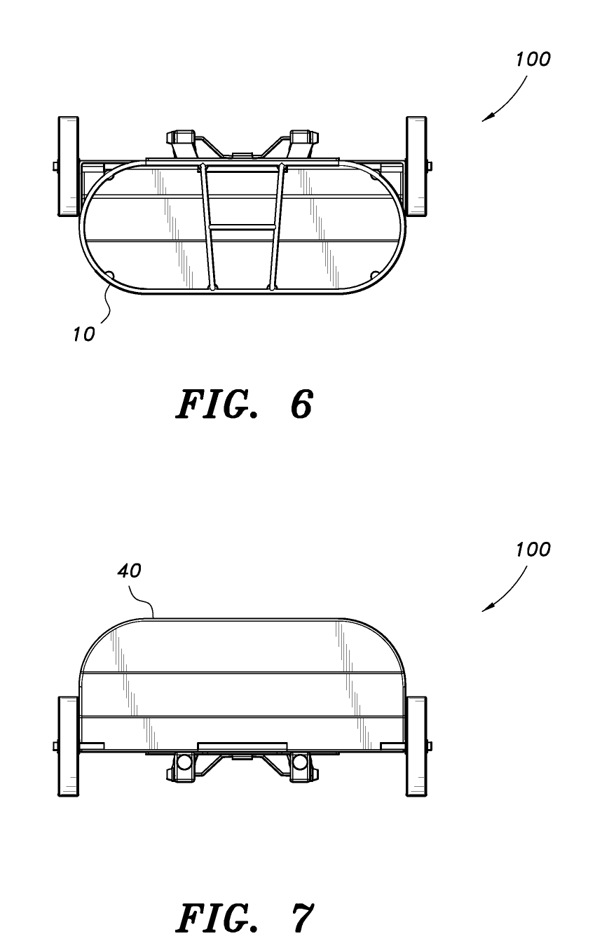

FIG. 6 is a top elevational view of the structure 100 of FIG. 1.

FIG. 7 is a bottom elevational view of the structure 100 of FIG. 1.

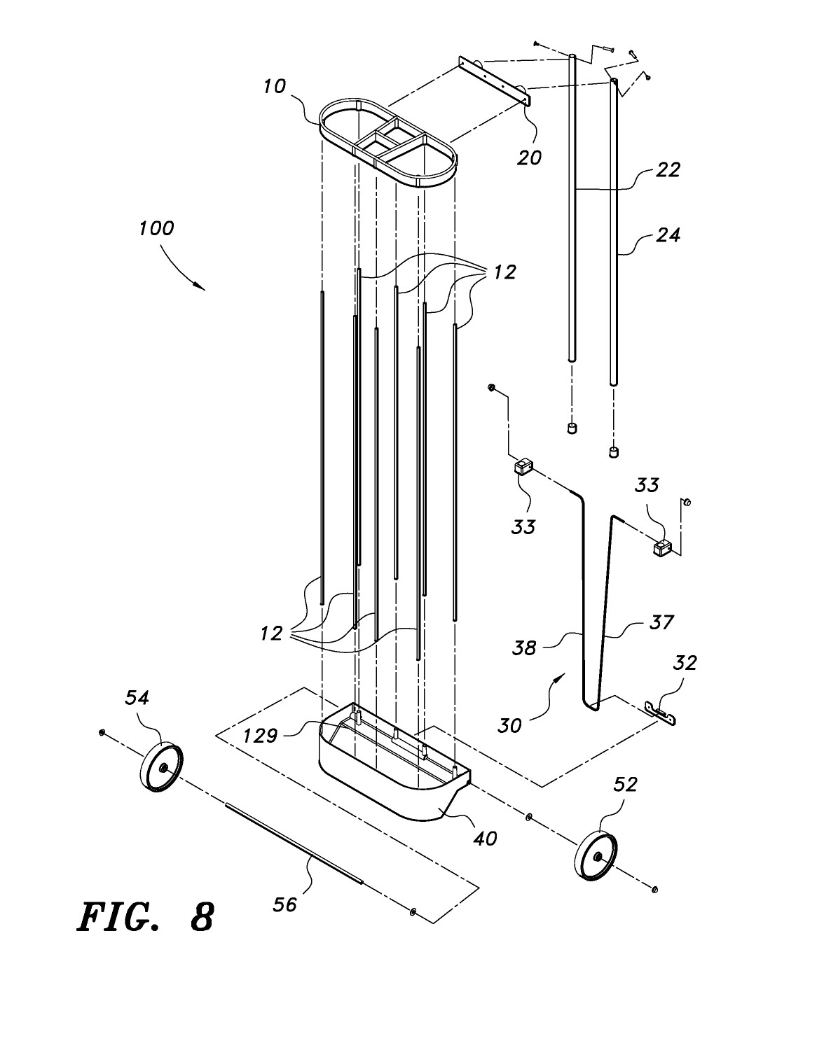

FIG. 8 is an explosed view of the structure 100 of FIGS. 1-7. The parts shown therein are as mentioned hereinabove, and are further described in detail in the following.

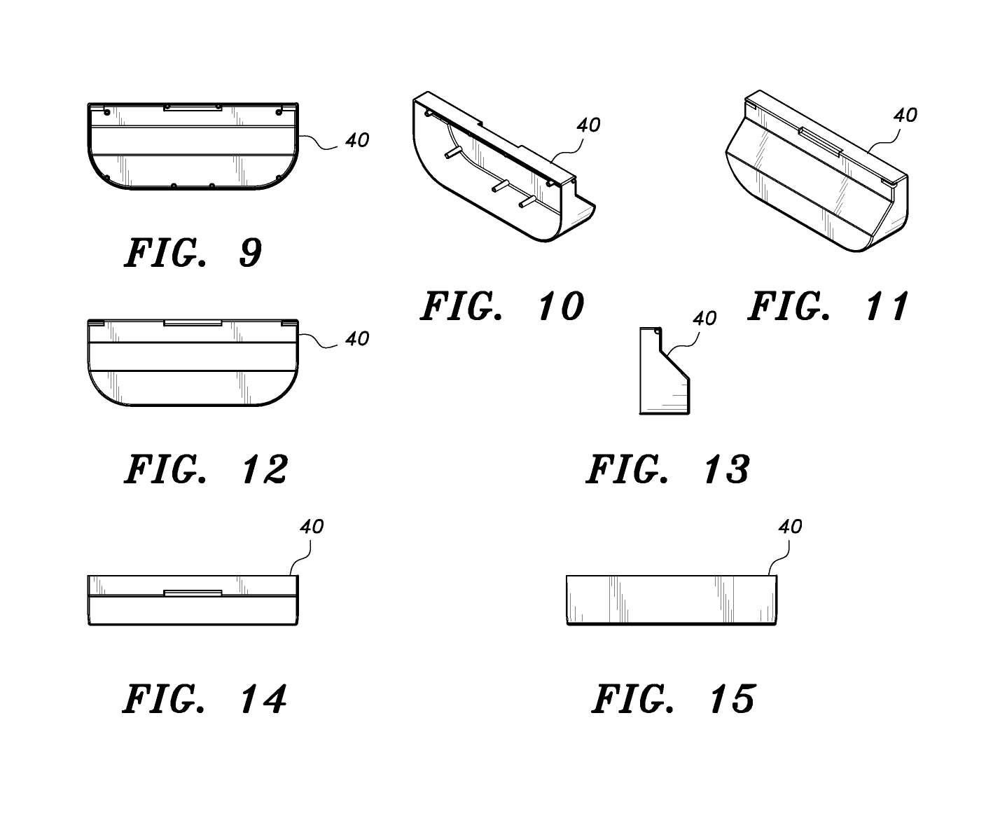

FIG. 9 is a top elevational view of a bottom member 40 used in the structure of FIG. 1. The bottom member 40 is generally pan-shaped, and having a peripheral lip portion (not numbered) and a plurality of tubular receiving portions (not numbered) for receiving respective ones of the rods 12. The assembly of the elements shown in FIG. 9 is as shown, and any one having skill in the mechanical assembly arts would know how to assemble the parts, select materials suitable for the parts and to select dimensions for the parts suitable to the intended purpose.

FIG. 10 is an isometric view of the bottom member 40 used in the structure of FIG. 1.

FIG. 11 is an isometric view of the bottom member 40 as viewed from the rear of FIG. 10.

FIG. 12 is a bottom elevational view of the bottom member 40 of FIG. 9.

FIG. 13 is a side elevational view of the bottom member 40 of FIG. 9.

FIG. 14 is a rear elevational view of the bottom member 40 of FIG. 9.

FIG. 15 is a front elevational view of the bottom member 40 of FIG. 9.

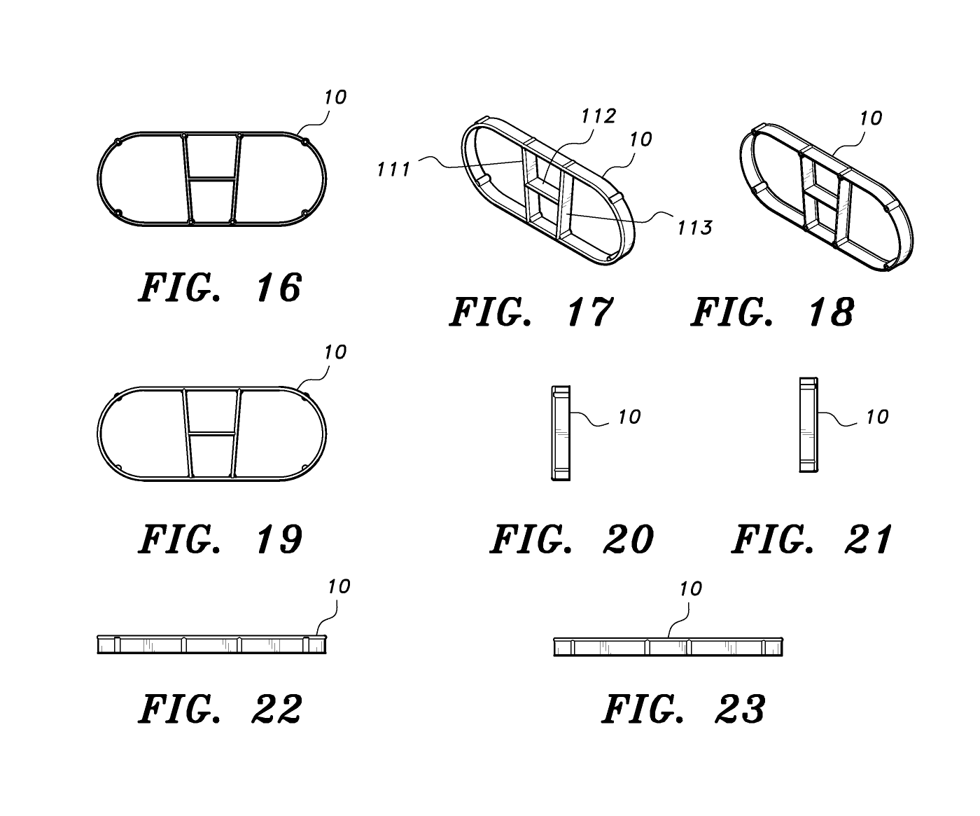

FIG. 16 is a top elevational view of a top member 10 used in the structure of FIG. 1. The top member 10 has the H-shaped portion 11 as mentioned hereinabove, formed by bars 111, 112, and 113. The H-shape has a wide end and a narrow end as shown.

FIG. 17 is an isometric view of the top member 10 used in the structure of FIG. 1.

FIG. 18 is an isometric view of the top member 10 as viewed from the rear of FIG. 17.

FIG. 19 is a bottom elevational view of the top member 10 of FIG. 16.

FIG. 20 is a right side elevational view of the top member 10 of FIG. 16.

FIG. 21 is a left side elevational view of the top member 10 of FIG. 16.

FIG. 22 is a rear elevational view of the top member 10 of FIG. 16.

FIG. 23 is a front elevational view of the top member 10 of FIG. 16.

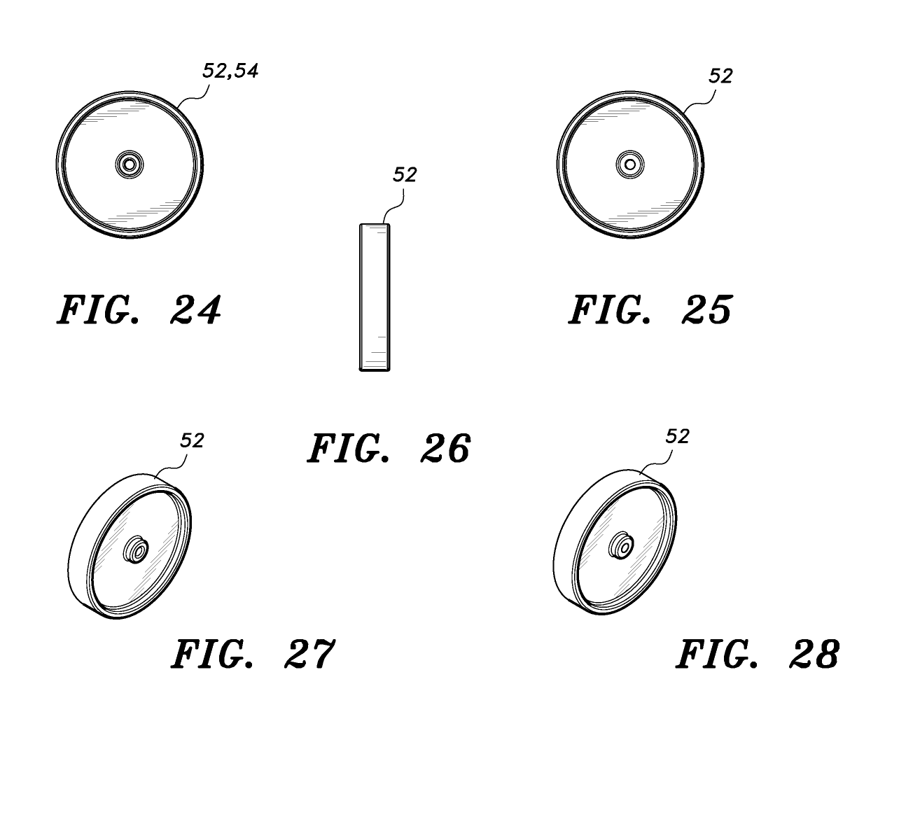

FIG. 24 is a front elevational view of a wheel 52 used in the support structure 100 of FIG. 1. Another wheel 54 is also provided, identical to the wheel 52.

FIG. 25 is a rear elevational view of the wheel 52 of FIG. 24.

FIG. 26 is a side elevational view of the wheel 52 of FIG. 24.

FIG. 27 is an isometric view of the wheel 52 of FIG. 24.

FIG. 28 is an isometric view of the wheel 52 of FIG. 24, viewed from the rear of FIG. 27.

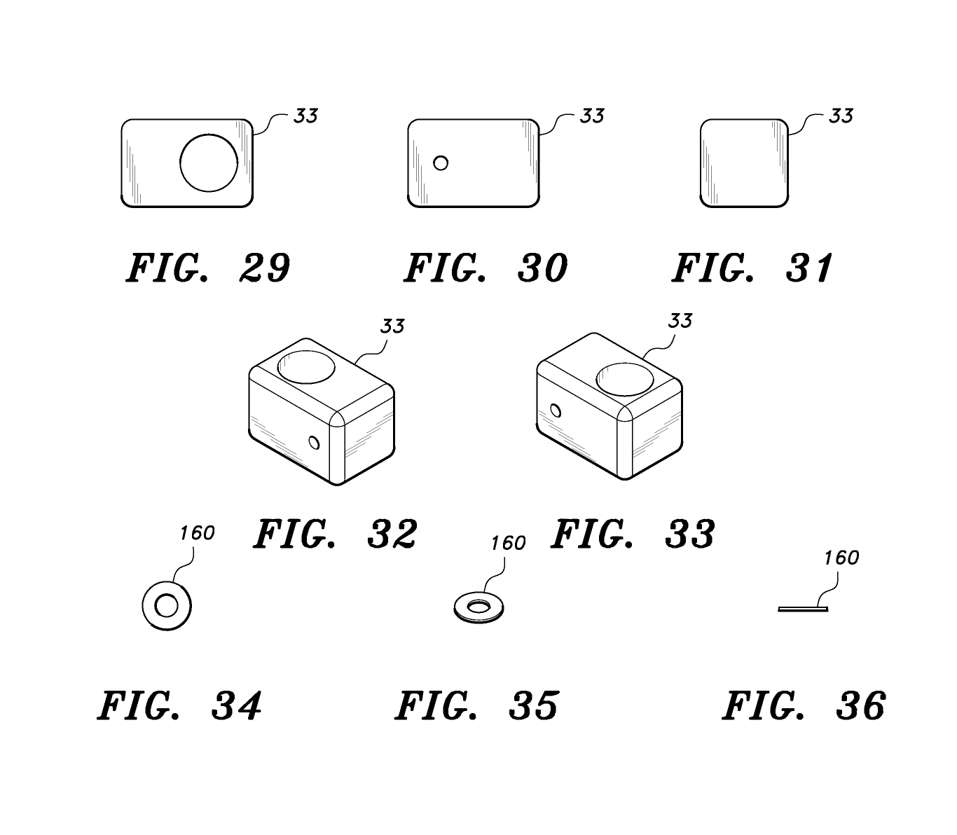

FIG. 29 is a top elevational view of a connector member 33 used in the support structure 100 of FIG. 1. The connector member 33 is generally block-shaped, and has a large opening for receiving a fastener and a small opening for receiving the pivotable support member 30.

FIG. 30 is a bottom elevational view of the connector member 33 of FIG. 29.

FIG. 31 is a side elevational view of the connector member 33 of FIG. 29.

FIG. 32 is an isometric view of the connector member 33 of FIG. 29.

FIG. 33 is an isometric view of the connector member 33 of FIG. 29, as viewed from the rear of FIG. 32.

FIG. 34 is a top elevational view of a washer member 160 used in the support structure 100 of FIG. 1.

FIG. 35 is an isometric view of the washer member 160 of FIG. 34.

FIG. 36 is a side view of the washer member 160 of FIG. 34.

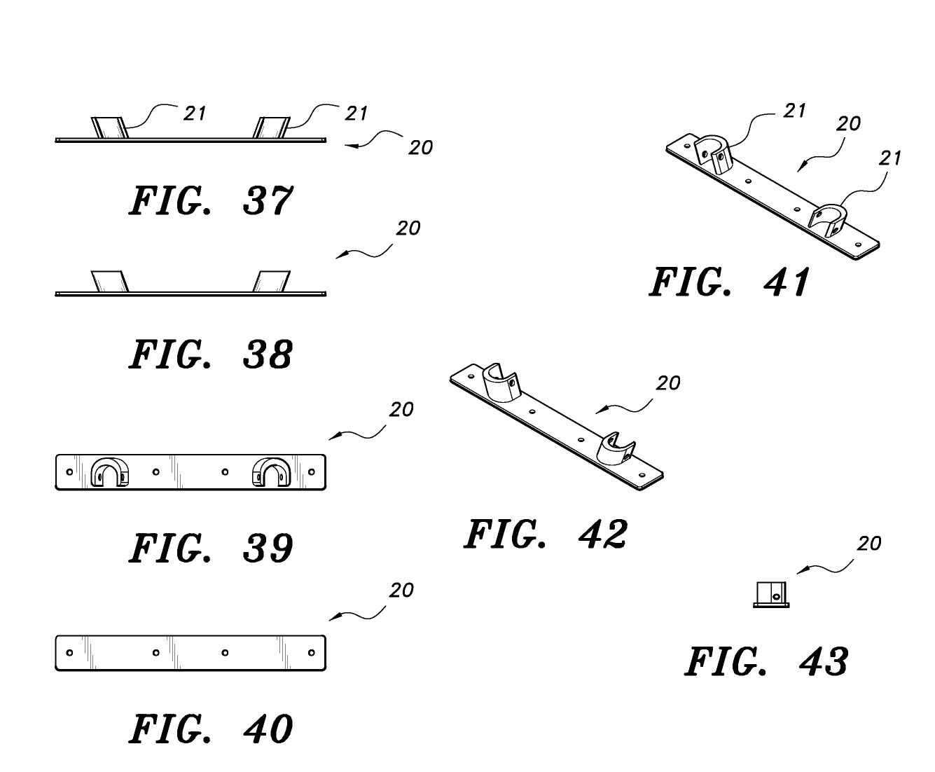

FIG. 37 is a bottom elevational view of a bracket 20 used in the support structure 100 of FIG. 1. The bracket 20 has a pair of projecting portions 22, 22 which have semi-circular cross sectional shapes. The bracket 20 has a plurality of mounting holes (unnumbered) therein.

FIG. 38 is a top elevational view of the bracket 20 of FIG. 37.

FIG. 39 is a rear elevational view of the bracket 20 of FIG. 37.

FIG. 40 is a front elevational view of the bracket 20 of FIG. 37.

FIG. 41 is an isometric view of the bracket 20 of FIG. 37.

FIG. 42 is an isometric view of the bracket 20 of FIG. 37, as viewed from the rear of FIG. 41.

FIG. 43 is a side elevational view of the bracket 20 of FIG. 37.

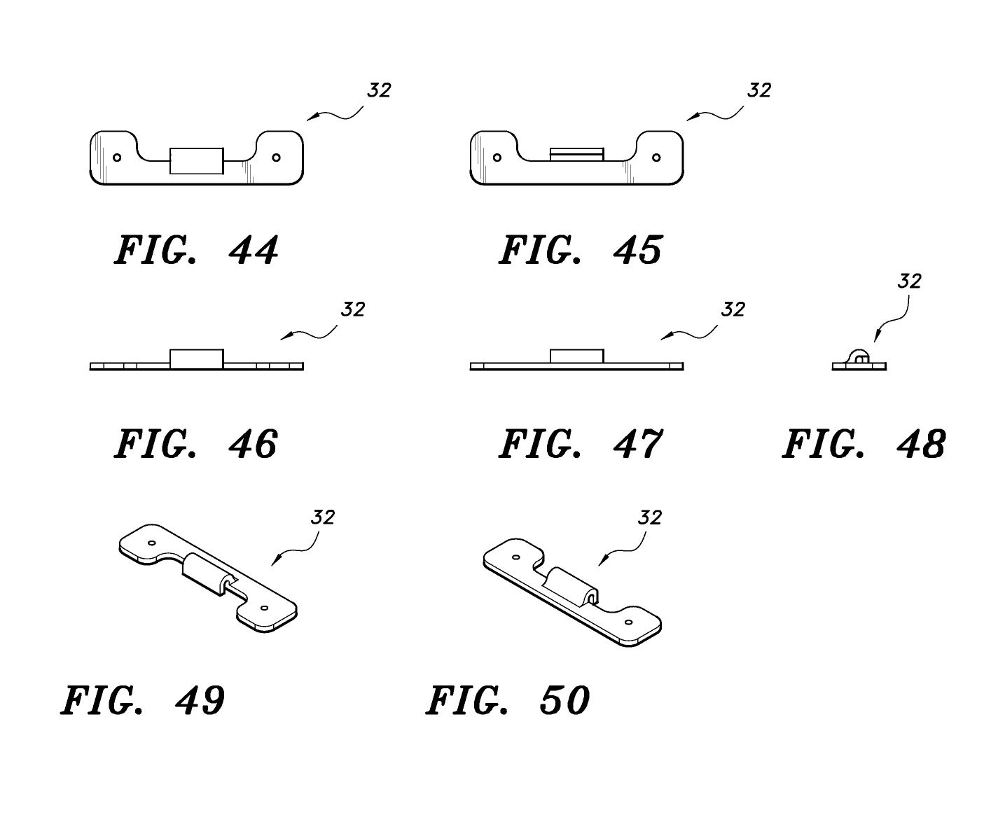

FIG. 44 is a front elevational view of a pivot support member 32 used in the support structure 100 of FIG. 1. The pivot support member 32 has two wings with mounting holes, and a central curved portion which traps the lower end of the pivotable support member 30 to enable pivoting motion thereof.

FIG. 45 is a rear elevational view of the pivot support member 32 of FIG. 44.

FIG. 46 is a bottom elevational view of the pivot support member 32 of FIG. 44.

FIG. 47 is a top elevational view of the pivot support member 32 of FIG. 44.

FIG. 48 is a side elevational view of the pivot support member 32 of FIG. 44.

FIG. 49 is an isometric view of the pivot support member 32 of FIG. 44.

FIG. 50 is an isometric view of the pivot support member 32 of FIG. 44, as viewed from the rear of FIG. 49.

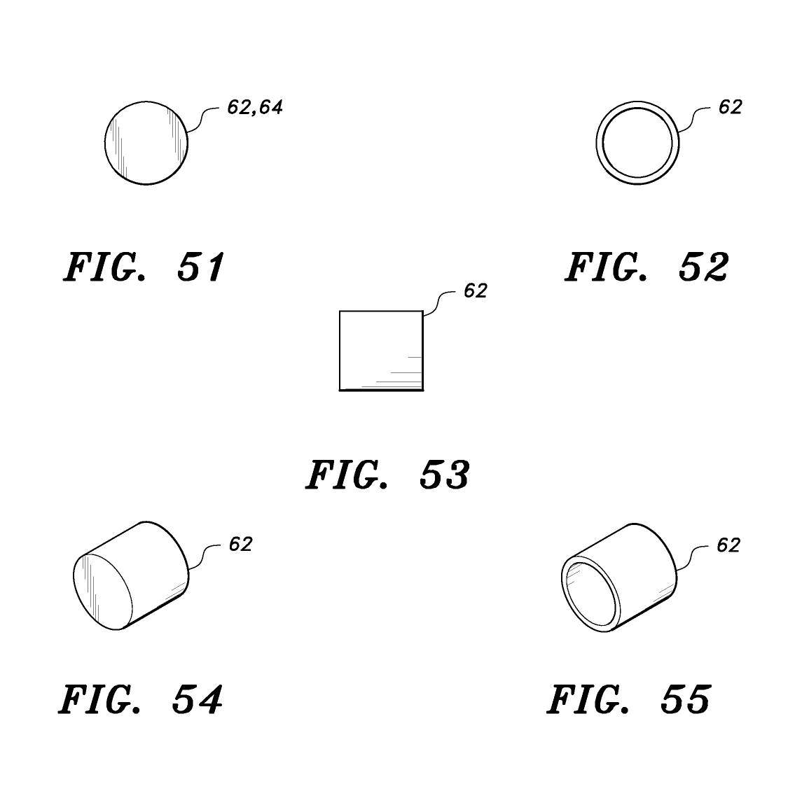

FIG. 51 is a bottom elevational view of an end cap 62 used in the support structure 100 of FIG. 1. An identical end cap 64 is also provided, shown in the preceding figures. The end cap 62 can be composed of rubber, plastic, or other material suitable for covering a tubular member.

FIG. 52 is a top elevational view of the end 62 cap of FIG. 51.

FIG. 53 is a side elevational view of the end cap 62 of FIG. 51.

FIG. 54 is an isometric view of the end cap 62 of FIG. 51.

FIG. 55 is an isometric view of the end cap 62 of FIG. 51, as viewed from the rear of FIG. 54.

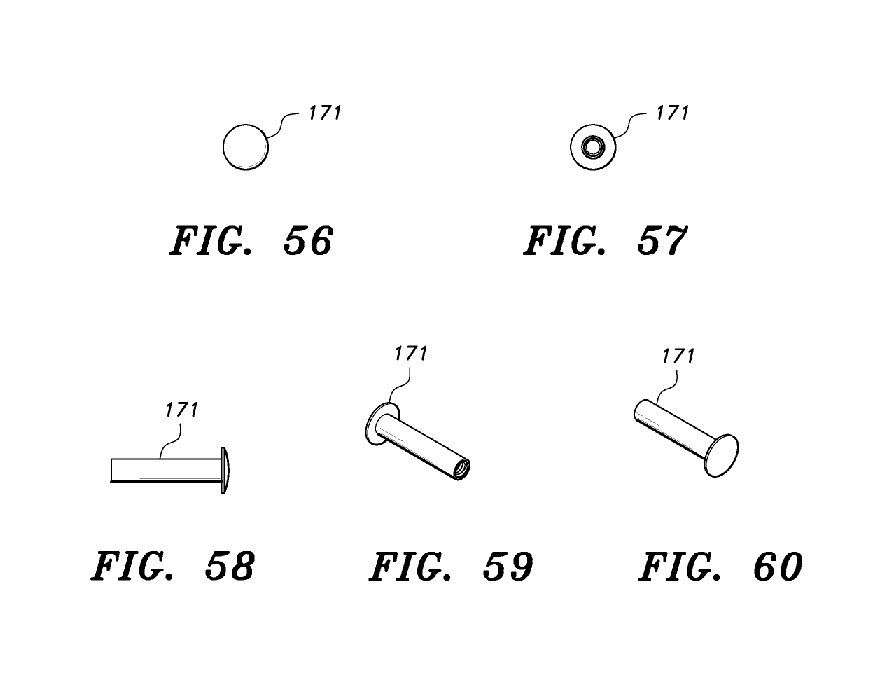

FIG. 56 is a top elevational view of a pin 171 used in the support structure 100 of FIG. 1.

FIG. 57 is a bottom elevational view of the pin 171 of FIG. 56.

FIG. 58 is a side elevational view of the pin 171 of FIG. 56.

FIG. 59 is an isometric view of the pin 171 of FIG. 56.

FIG. 60 is an isometric view of the pin 171 of FIG. 56, as viewed from the rear of FIG. 59.

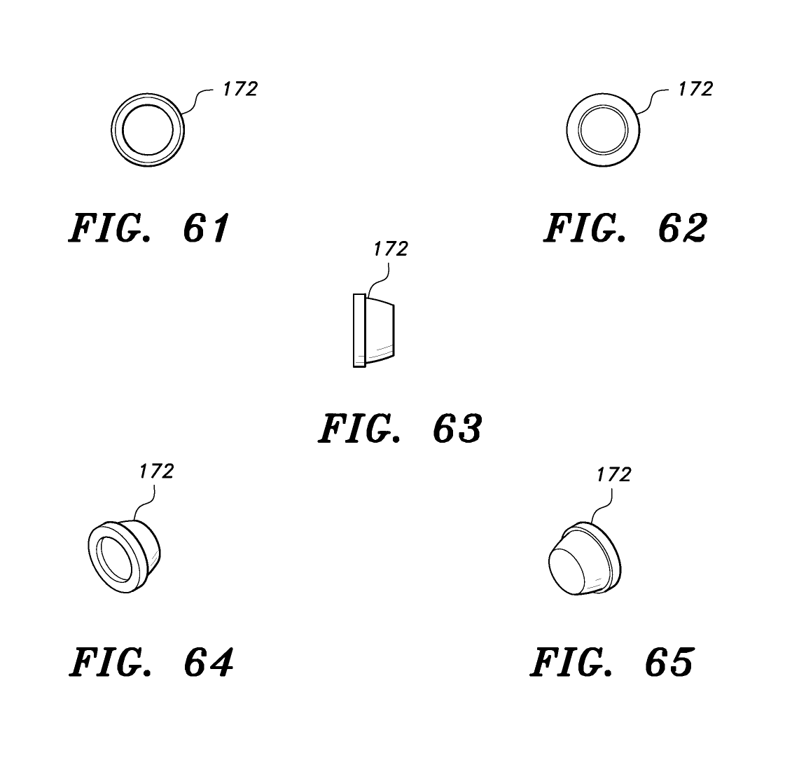

FIG. 61 is a bottom elevational view of a cover 172 used in the support structure 100 of FIG. 1.

FIG. 62 is a top elevational view of the cover 172 of FIG. 61.

FIG. 63 is a side elevational view of the cover 172 of FIG. 61.

FIG. 64 is an isometric view of the cover 172 of FIG. 61.

FIG. 65 is an isometric view of the cover 172 of FIG. 61, as viewed from the rear of FIG. 64.

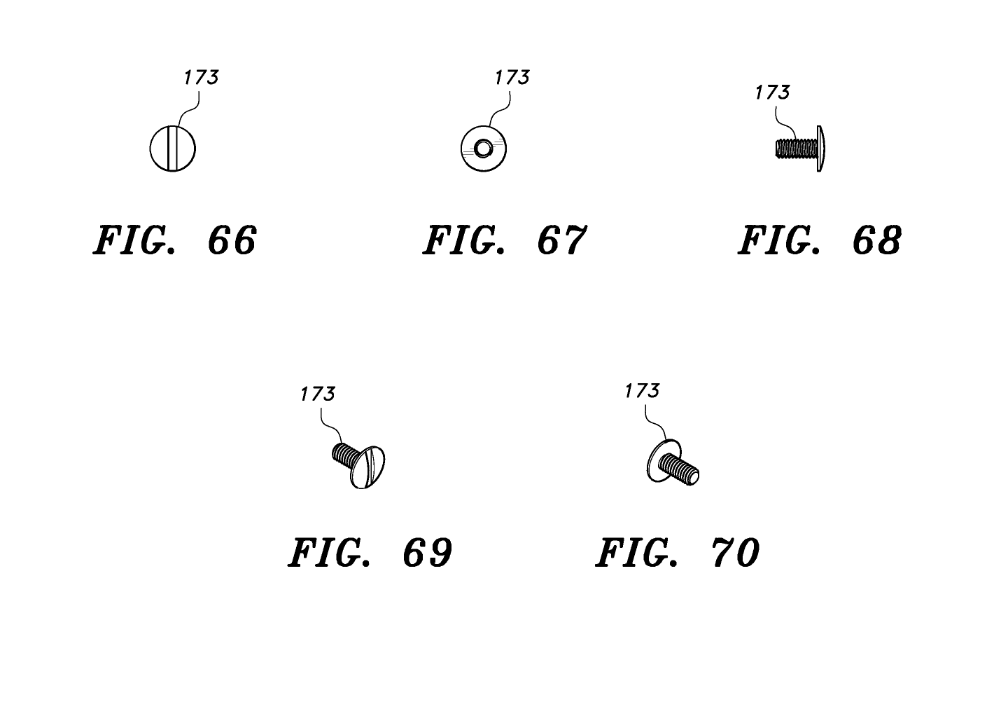

FIG. 66 is a top elevational view of a threaded fastener 173 used in the support structure 100 of FIG. 1.

FIG. 67 is a bottom elevational view of the threaded fastener 173 of FIG. 66.

FIG. 68 is a side elevational view of the threaded fastener 173 of FIG. 66.

FIG. 69 is an isometric view of the threaded fastener 173 of FIG. 66.

FIG. 70 is an isometric view of the threaded fastener 173 of FIG. 66, as viewed from the rear of FIG. 69.

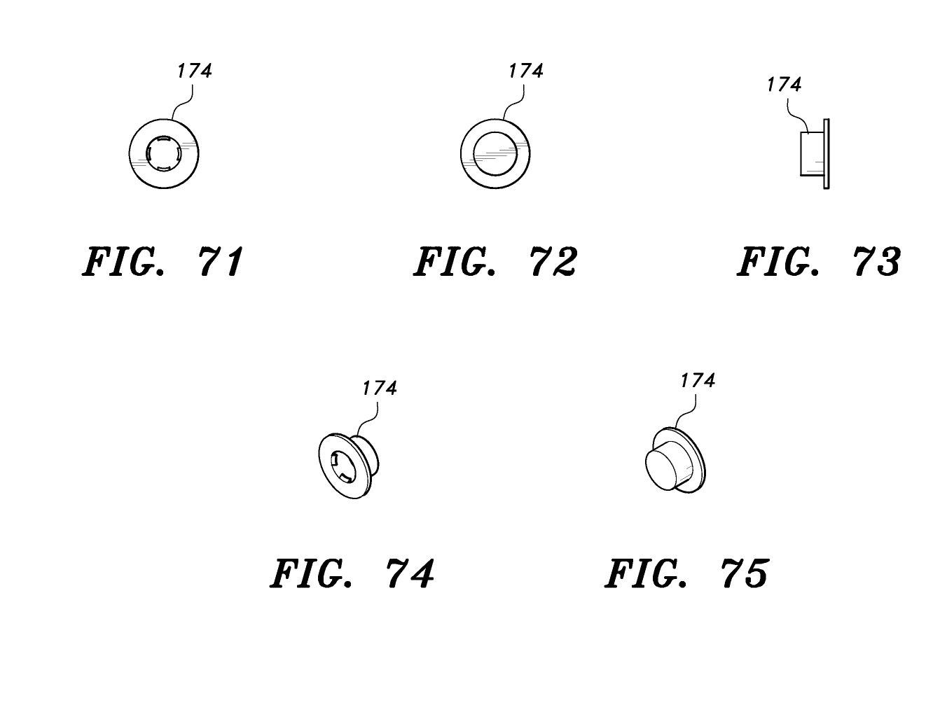

FIG. 71 is a rear elevational view of an end cap 174 used in the support structure 100 of FIG. 1.

FIG. 72 is a front elevational view of the end cap 174 of FIG. 71.

FIG. 73 is a side elevational view of the end cap 174 of FIG. 71.

FIG. 74 is an isometric view of the end cap 174 of FIG. 71.

FIG. 75 is an isometric view of the end cap 174 of FIG. 71, as viewed from the rear of FIG. 74.

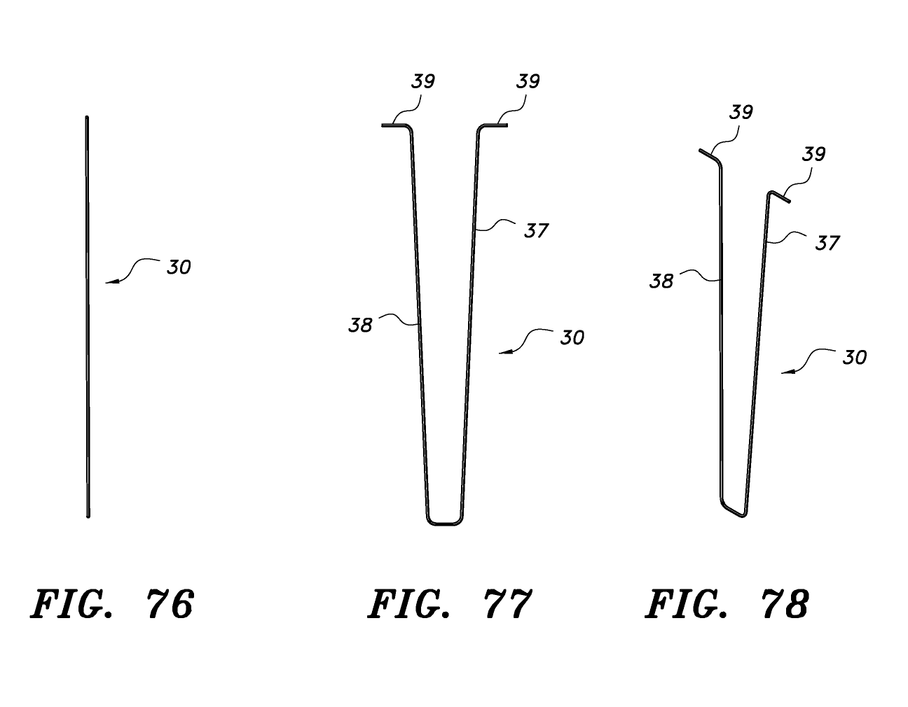

FIG. 76 is a side elevational view of a pivotable support member 30 used in FIG. 1. The pivotable support member 30 has a pair of legs 37, 38 connected at one end to form a U-shape, and having a pair of outwardly-extending ends 39, 39 which are oppositely directed. The ends 39, 39 are secured in the large openings in the connector members 33, 33, for pivotable motion.

FIG. 77 is a front elevational view of the pivotable support member 30 of FIG. 76.

FIG. 78 is an isometric view of the pivotable support member 30 of FIG. 76.

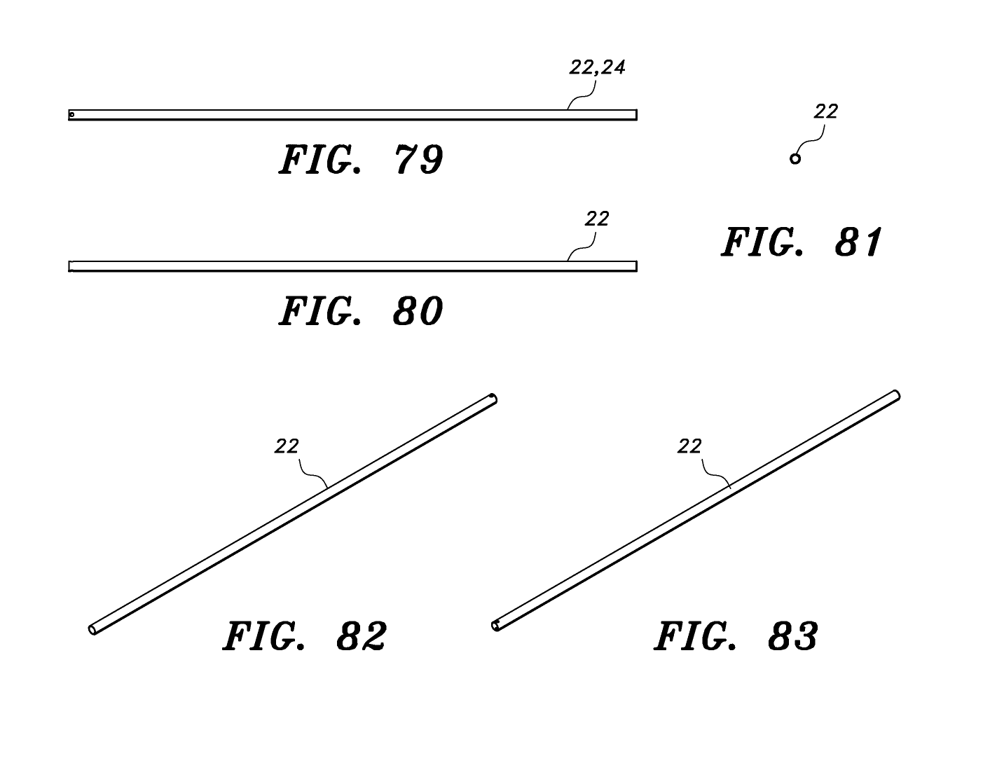

FIG. 79 is a front elevational view of a support leg 22 used in FIG. 1. The support leg 22 is identical to the support leg 24 described in the preceding.

FIG. 80 is a rear elevational view of the support leg 22 of FIG. 79.

FIG. 81 is an end elevational view of the support leg 22 of FIG. 79.

FIG. 82 is an isometric view of the support leg 22 of FIG. 79.

FIG. 83 is an isometric view of the support leg 22 of FIG. 79, as viewed from the rear of FIG. 82.

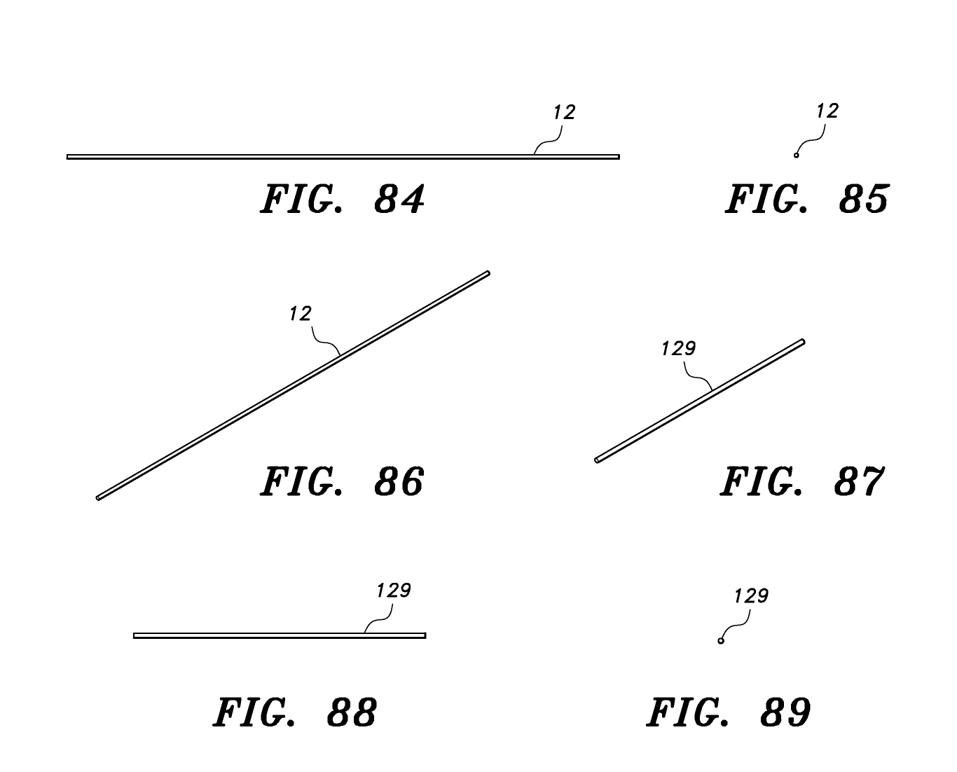

FIG. 84 is a front elevational view of a long support rod 12 used in FIG. 1.

FIG. 85 is an end elevational view of the long support rod 12 of FIG. 84.

FIG. 86 is an isometric view of the long support rod 12 of FIG. 84.

FIG. 87 is an isometric view of a short support rod 129 used in FIG. 1.

FIG. 88 is a side elevational view of the long support rod 129 of FIG. 87.

FIG. 89 is an end view of the long support rod 129 of FIG. 87.

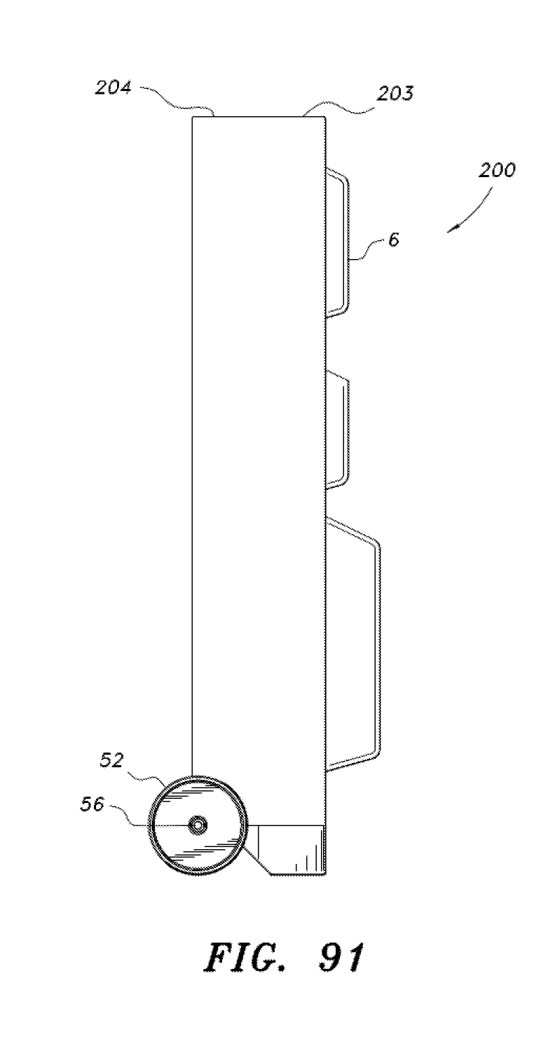

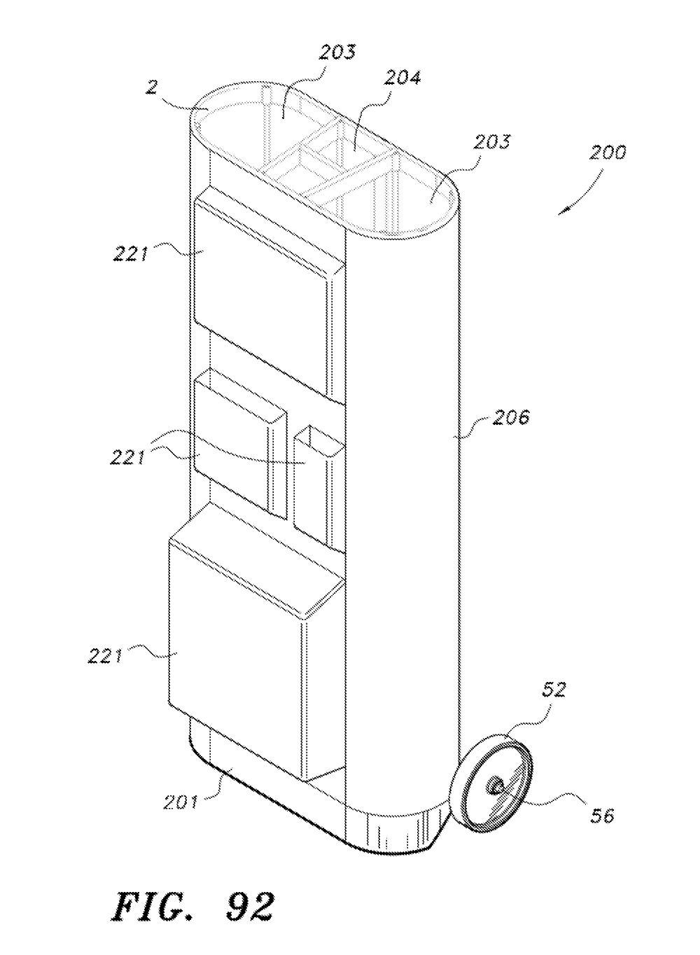

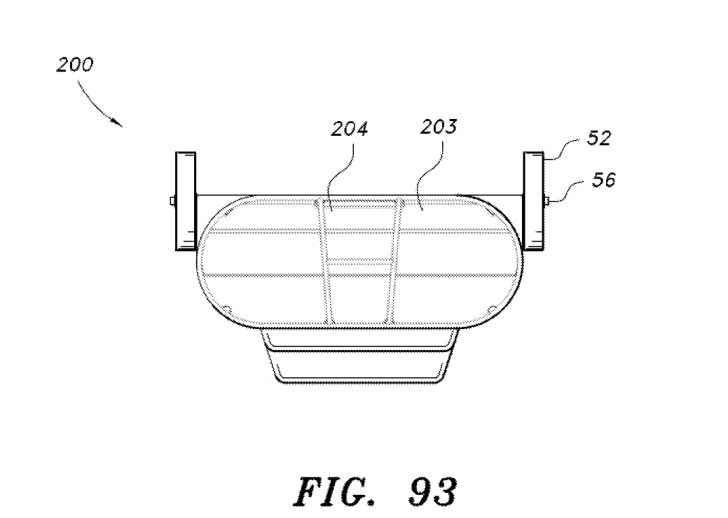

FIG. 90 is a front view of a wheeled compartmentalized cart 200. The cart of FIG. 90, which is also shown in FIG. 91, FIG. 92, and FIG. 93, includes a base 201, an axle 56, wheels 52, a bag 6 having assorted pockets 221, a pair of large compartments 203, and a pair of small compartments 204.

The above-mentioned pockets are preferably as shown, and can be varied in number, size, shape, and/or location. All such variations would be within the ambit of any one having skill in the pocket-making arts.

FIG. 91 is a side view of the wheeled compartmentalized cart 200 of FIG. 90. The parts are as named and described above.

FIG. 92 is an isometric view of the wheeled compartmentalized cart 200 of FIGS. 90 and 91. The parts are as named and described above, and in addition a cap 2 is shown, along with a top view of the two compartments 203, 203. The small compartments 204 are shown in relation to the other compartments.

FIG. 93 is a top view of the wheeled compartmentalized cart 200 of FIGS. 90-92. The parts are as named and described above.

The cart 200 of the present invention, as shown in the attached drawings and as described hereinabove, is adapted for the following uses. The cart 200 of the present invention is a rolling cart, coming in multiple configurations, that allow a spectator to carry folding camp chairs, shade canopies/umbrellas, etc. to an event.

In one embodiment of the present invention, the cart 200 is designed to carry chairs and a large shade umbrella. The cart, regardless of configuration, will also contain a number of convenience pockets to carry stadium blankets, binders, tablet PCs, sunscreen, etc. It also contains a large pocket with a thermal lining (not shown) in which to carry beverages. This pocket and lining is removable in order to facilitate washing in the event of a spilled beverage. This embodiment is designed with a shoulder strap (not shown) which facilitates hands-free towing. This is especially helpful for the average “soccer mom” who needs those hands free to corral children while in transit to an event.

The invention being thus described, it will be evident that the same may be varied in many ways. Such variations are not to be regarded as a departure from the spirit and scope of the invention and all such modifications are intended to be included within the scope of the claims.

What is claimed is:

1. A cart for use in transportation of participation and spectator equipment to and from events, comprising: a base, an axle, wheels, a bag having assorted pockets, a pair of large compartments and a pair of small compartments.

2. A cart for use in transportation of participation and spectator equipment to and from events, comprising:
a base,
an axle,
wheels supported on said axle,
a bag having a plurality of pockets,
at least one large compartment, and
at least one small compartment tube.

3. A cart for use in transportation of participation and spectator equipment to and from events, comprising:
a base,
an axle,
wheels supported on said axle,
a top member having an outer peripheral band portion and a central H-shaped portion;
a pair of main support legs connected to one side of said top member;
a plurality of long rods separating said top member and said base;
a pivotable member connected to said pair of main support legs; and
a bag having a plurality of pockets.
